(19) United States
(12) Patent Application Publication
(10) Pub. No.: US 2001/0032105 A1
(43) Pub. Date: Oct. 18, 2001

(54) Method and system for introducing a new project initiative into a business

(76) Inventors: Robert Bruce Frye, Schenectady, NY (US); Jean Marie Hubert Heuschen, Williamstown, MA (US); James Patrick Kindlon, West Sand Lake, NY (US); Jerome Forest Parmer JR., Southington, CT (US); Yimin Jin, Glenmont, NY (US)

Correspondence Address: Thomas M. Blasey, Esq., Hunton & Williams, Suite 1200, 1900 K Street, N.W., Washington, DC, 20006, US

(21) Appl. No.: 09/750,906

(22) Filed: Jan. 2, 2001

Related U.S. Application Data
(60) Provisional application No. 60/173,701, filed on Dec. 30, 1999.

(51) Int. Cl. G06F 17/60

(52) U.S. Cl. 705/7

(57) ABSTRACT

A method and system for introducing a new project initiative into a business. Once it has been decided that a need exists and that an initiative should be developed, a computer system receives project information from a requesting party and lays out all required elements to successful project implementation in a systematic series of stages, milestones and checklists. A variety of milestone and checklists are completed for each stage and relevant documentation is electronically attached and referenced in the computer system. A stage approver is then electronically notified by the computer system that a stage approval needs to be made. In response to this notice, the stage approver reviews the collected information and makes a determination as to whether the project should advance to the next stage. If a stage approval is received, the requesting party is electronically notified and the various milestones and checklists corresponding to the next stage are undertaken. By progressing through all stages, information is shared rapidly and efficiently and creates a system of record for new project initiative introductions which may be subsequently searched and referenced.

### CROSS REFERENCE TO RELATED APPLICATIONS

This application claims the benefit of provisional patent application Ser. No. 60/173,701, filed Dec. 30, 1999, the disclosure of which is incorporated herein by reference.

### BACKGROUND OF THE INVENTION

The present invention relates generally to systems and methods for initiating and implementing projects and other initiatives into business organizations. More particularly, the present invention relates to providing a comprehensive system for facilitating the introduction of new project initiatives and processes into a business.

Conventionally, distributed global manufacturing and design companies have struggled to efficiently introduce new projects, products and/or processes into their design systems. Because of inherent differences in both site development and requirements, conventional project introduction processes generally evolve differently at each site, thereby requiring time consuming translation and searching across the different sites in order to avoid inconsistent or redundant determinations. Further, multiple considerations must be taken into account when determining whether to approve the introduction of a given initiative. Diverse considerations such as market conditions, project development concerns and implementation efforts all affect the success or failure of particular project. Since determinations regarding the introduction of initiatives are necessarily made at multiple levels, the merging of dissimilar systems and the physical documentation associated with each system further compounds the inefficiency in conventional project introduction methods.

Therefore, there is a need in the art of product design systems to facilitate the introduction of new or modified initiatives into the system. There is a further need for a method and system for providing globalized, automated introduction of initiatives across distributed locations.

### BRIEF SUMMARY OF THE INVENTION

The present invention overcomes the problems noted above, and provides additional advantages, by providing for a comprehensive method and system for introducing a new initiative into a product design system. Once it has been decided that a need exists and that an initiative should be developed, a computer system receives project information from a requesting party and lays out all required elements to successful project implementation in a systematic series of stages, milestones and checklists. A variety of milestone and checklists are completed for each stage and relevant documentation is electronically attached and referenced in the computer system. A stage approver is then electronically notified by the computer system that a stage approval needs to be made. In response to this notice, the stage approver reviews the collected information and makes a determination as to whether the project should advance to the next stage. If a stage approval is received, the requesting party is electronically notified and the various milestones and checklists corresponding to the next stage are undertaken. By progressing through all stages, information is shared rapidly and efficiently and creates a system of record for new project initiative introductions which may be subsequently searched and referenced.

By providing a comprehensive and uniform process for designing and implementing a new initiative, the system of the present invention, substantially increases the ability for distributed locations to stay in tune with what each other are doing. Further, because all products or processes in every location must be introduced in accordance with the present system, added consistency results. In addition to consistency, the above described invention further provides for a uniform system of record for all product or process introductions, whether successful or unsuccessful. Consequently, future developers may search the system to determine if similar work had been done in the past. Further, because of the computer-based nature of the inventive system, transitions between stages are streamlined through electronic notifications and file attachments.

### BRIEF DESCRIPTION OF THE DRAWINGS

The present invention can be understood more completely by reading the following Detailed Description of exemplary embodiments, in conjunction with the accompanying drawings, in which:

FIG. 1 is a flow chart describing a preferred general embodiment for introducing a new initiative into a business;

FIG. 2 is a flow chart describing a discrete collection of project development stages and associated tollgates;

FIG. 3 is a flow chart describing one preferred operation of the first stage set forth in FIG. 2;

FIG. 4 is a flow chart describing one preferred operation of the second stage set forth in FIG. 2;

FIG. 5 is a flow chart describing a preferred embodiment of a system for facilitating the various tasks set forth in the second stage;

FIG. 6 is a flow chart describing a preferred embodiment of a method for displaying and receiving the second stage milestone and checklist information;

FIG. 7 is a flow chart describing one preferred operation of the third stage set forth in FIG. 2;

FIG. 8 is a flow chart describing a preferred embodiment of a system for facilitating the various tasks set forth in the third stage;

FIG. 9 is a flow chart describing one method for performing freedom to practice and environmental health and safety assessments in accordance with the present invention;

FIG. 10 is a flow chart describing one preferred operation of the fourth stage set forth in FIG. 2;

FIG. 11 is a flow chart describing a preferred embodiment of a system for facilitating the various tasks set forth in the fourth stage;

FIG. 12 is a flow chart describing one preferred operation of the fifth stage set forth in FIG. 2;

FIG. 13 is a flow chart describing a preferred embodiment of a system for facilitating the various tasks set forth in the fifth stage;

FIG. 14 is a flow chart describing one preferred operation of the sixth stage set forth in FIG. 2; and

FIG. 15 is a flow chart describing a preferred embodiment of a system for facilitating the various tasks set forth in the sixth stage.

### DETAILED DESCRIPTION OF THE INVENTION

The system and method of the present invention described below, are preferably implemented by an interactive computer software system incorporated within a computer-readable medium such as a hard disk drive, an optical medium such as a compact disk, or the like. Further, the medium is preferably available to a plurality of distributed users connected together over a computer network, such as a local area network (LAN), a wide area network (WAN), or the Internet. The inventive computer software system is designed to receive a plurality of project introduction information from a plurality of project participants. The application then facilitates the analysis, distribution, and implementation of this information.

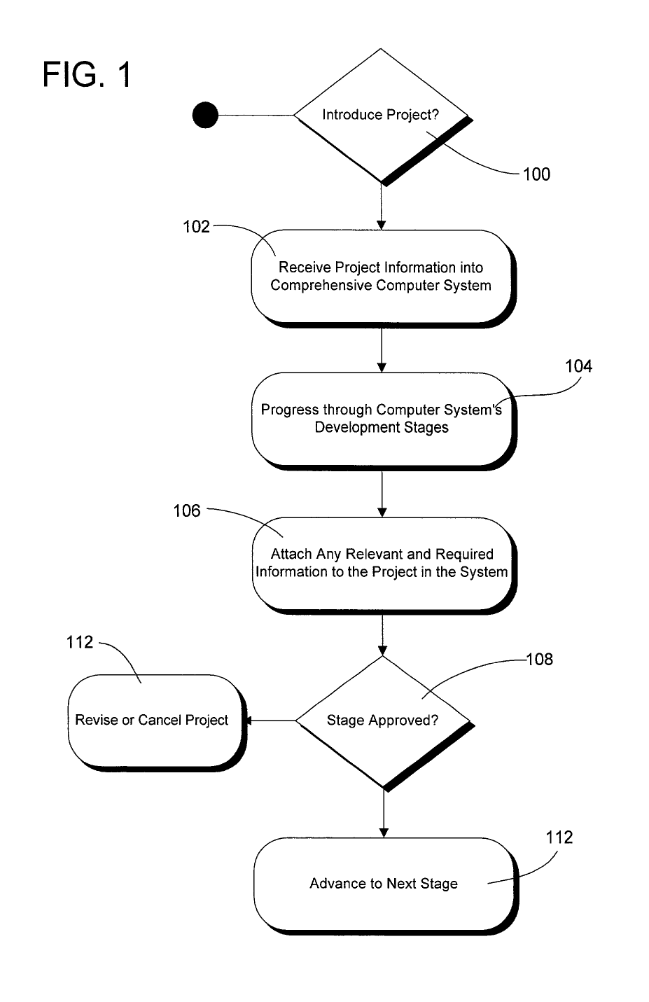

Referring to the Figures and, in particular, to FIG. 1, there is shown a flow chart describing a preferred general embodiment for introducing and implementing a new initiative into a business. In a first step 100, a business makes an initial determination as to whether or not a particular initiative should be introduced and developed. This determination is typically made based upon a perceived business advantage, such as a customer request, any required compliance with various laws and regulations, or improvements in prior products and/or processes. If it is determined in step 100 that the project should be introduced, information regarding the project is received into a computer system in step 102. The computer system is designed to facilitate and streamline the entire project introduction and eventual implementation process.

As described in additional detail below, step 104 involves progressing through a series of stages, each related to a specific segment of the project development process. Further, in a preferred embodiment, the computer system sets forth a variety of checklist elements and required milestones for each stage. In step 106, relevant disclosure materials and project participant identities and comments are attached to particular checklist items within the computer system. Next, in step 108, for each stage of the project development process, approvals are requested. If the approval for a stage is obtained, the status of that stage in the computer system is changed to complete and the process is advanced into the next stage in step 110. However, if approval is not obtained, the status is not changed, and the project must be either revised or canceled in step 112.

By providing for a single comprehensive computer system for managing, facilitating, and monitoring the process of a initiative's development, disparate working environments are better able to operate as an integrated unit. In particular, by requiring the project's systematic progression through a system of stages, checklists and milestones as well as the required approvals substantially assists an organization's ability to rapidly and accurately assess the best manner of developing and implementing the subject matter of the project.

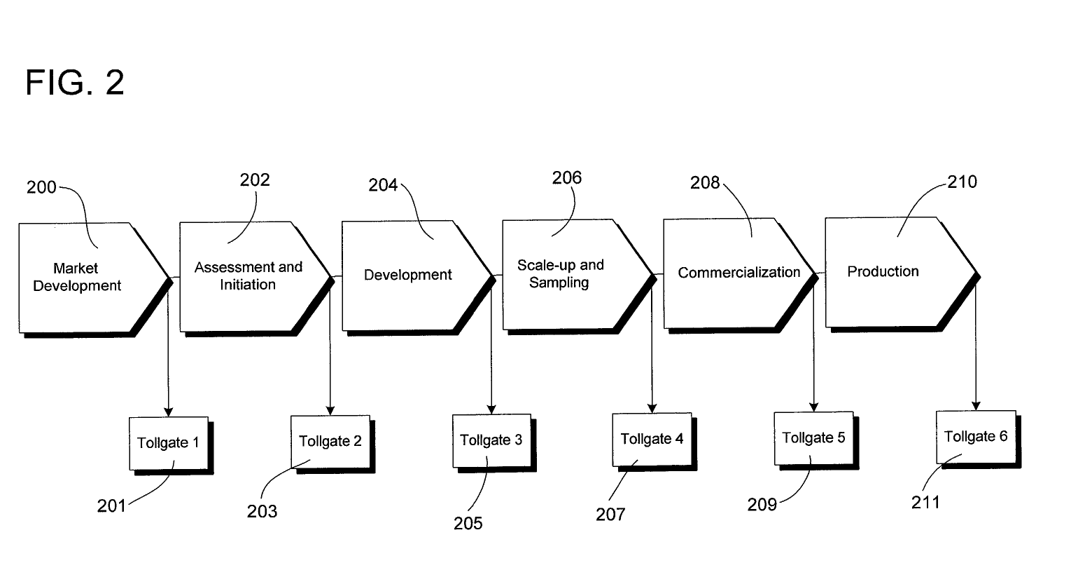

Referring now to FIG. 2, there is disclosed a flow chart describing a discrete collection of project development stages and associated tollgates. In particular, a preferred embodiment of the present system includes six discrete stages specifically related to: 1) market development (200); 2) assessment and initiation (202); 3) development (204); 4) scale-up and sampling (206); 5) commercialization (208); and 6) implementation (210). Prior to advancing from one stage to the next, at least one approver must approve the advancement. This approval process is generally referred to as a tollgate. Accordingly, for the above-described six stage embodiment, there are six discrete tollgates, 201, 203, 205, 207, 209 and 210, each of which must be passed before the project can advance to the next stage in its development.

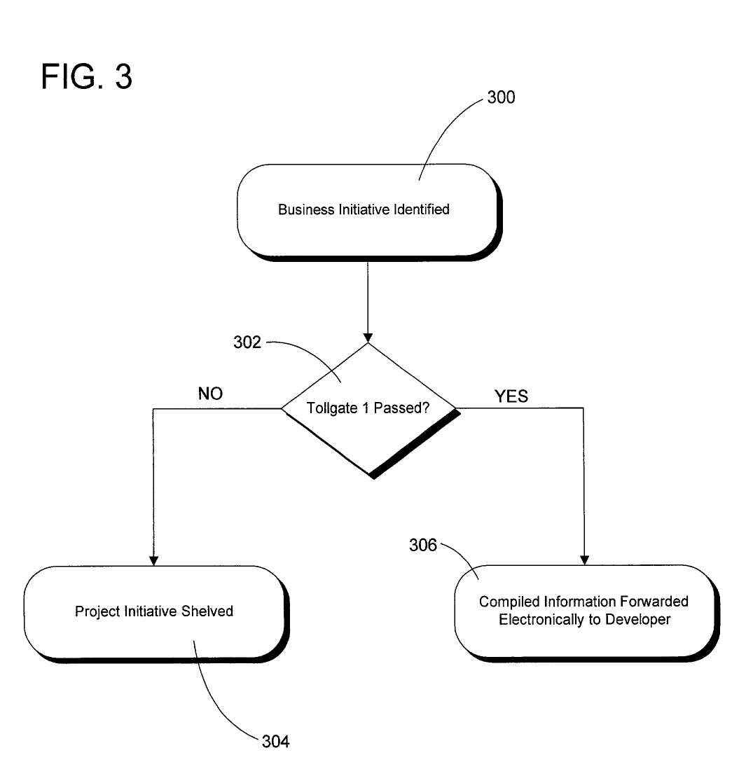

Referring now to FIG. 3, there is shown a flow chart describing one preferred operation of the first stage (200) set forth above relating to project inception and marketing development. In step 300, a business initiative is identified based upon a perceived market or benefit for the initiative. Business initiatives may include a wide variety of endeavors including: customer driven initiatives such as requested products, processes or changes to existing products or processes; new platform initiatives that typically involve the creation or modification of multiple products or processes aimed at specific target markets; breakthrough projects aimed primarily at research and development and not directed toward specific customers or markets; and capital investment opportunities such as company expansions and the like.

Once a business initiative has been identified, it is subjected, in step 302, to a marketing tollgate which includes an analysis by various marketing individuals charged with the responsibility of evaluating whether the initiative is worth pursuing. Typically, in making this determination, the marketing individuals review a variety of information such as the potential market for the initiative, its cost, any timing issues, the risks associated with the development of the initiative, etc. Additionally, a multigenerational application plan (MGAP) is preferably generated wherein the prospective phases of the initiative's implementation are disclosed and detailed. If it is determined in step 302 that the initiative is not suitable for immediate development and should therefore not pass the first tollgate, the initiative is shelved in step 304 and does not advance into the computer system for subsequent action. However, if it is determined that the initiative is suitable for development, the first tollgate is passed and the information compiled and generated during the review is forwarded electronically to a project developer in step 306, thus entering the second stage.

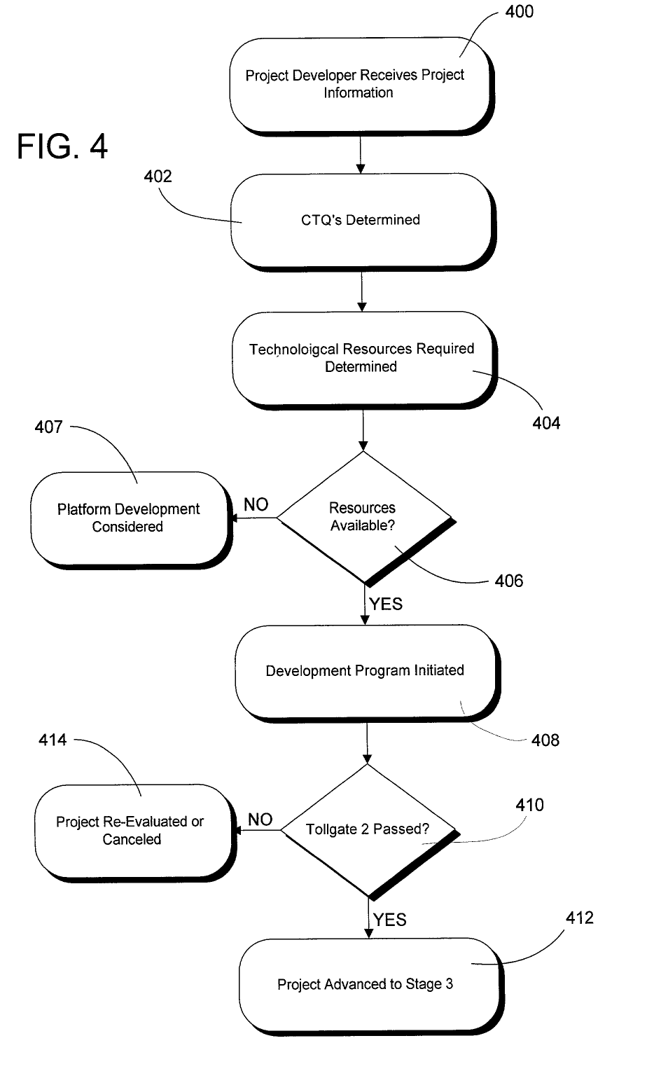

Referring now to FIG. 4, there is shown a flow chart describing one preferred operation of the second stage (202) set forth above relating to project assessment and initiation. In step 400, the project developer or development team (hereinafter “the developer”) receives the project marketing information compiled and generated by the marketing group in the first stage. In step 402, project features are identified which are determined to be critical to the project's quality, whether from a customer or internal prospective. Such features are generally referred to as CTQ's or Criticals to Quality. In step 404, the technological needs required to develop and implement the project are assessed. In step 406, it is determined whether the identified technological resources are available. If the technological resources are not available, platform development is considered in step 407. As briefly touched on above, platform development refers to development situations in which a new technology is introduced that should apply to several new products. It differs from a traditional new product (or process) introduction in that: 1) the development timeframe is generally longer; 2) the new technology or process should apply to several different products; and 3) a completion date is generally not guaranteed to a customer. However, if the resources determined to be presently available, a development program is initiated in step 408 to introduce the subject matter of the project to a plurality of relevant personnel for the purposes of analysis and review. At this point, all collected assessment and initiation information and related decisions are subjected to a second tollgate in step 410.

As defined briefly above, a tollgate is generally a checkpoint in a project's progression and involves a meeting between the various members of the cross-functional team. During the meeting, which is preferably held in an online environment, the team members discuss the current state of the project and each member renders an opinion as to whether or not the tollgate should be passed. In a preferred embodiment, a single individual is then charged with the task of reviewing all materials and comments and making a decision regarding the present tollgate. If it is determined that the program shows sufficient likelihood for success, the tollgate is passed in step 412 and the project proceeds to the third stage. However, if the second tollgate is not passed, the project is either re-evaluated or canceled in step 414.

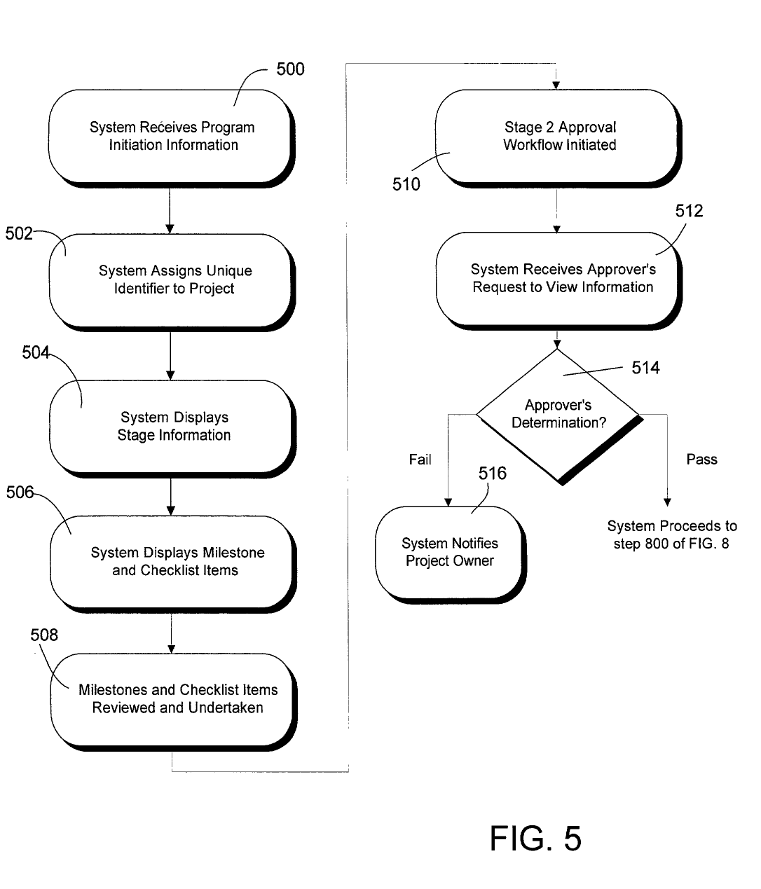

Referring now to FIG. 5, there is shown a flow chart describing a preferred embodiment of a system for facilitating the various tasks set forth in the second stage. In step 500, the comprehensive computer system briefly described above receives program initiation information from the developer. Preferably, this information includes at least an identification of the type of program being initiated (e.g., new product, breakthrough, etc.) as well as an identification as to an owner for the program. Further, the project marketing information received from the marketing group in the first stage is attached to the program in the computer system. In step 502, the computer system assigns a unique identifier to the program so that all information collected may be easily stored together and subsequently retrieved. In step 504, the computer system displays stage information to the developer indicating that the first stage is complete and that the project is now in second stage. Further, the computer system also preferably displays a listing of all stages to be completed so as to provide system users with knowledge about what will be done in the future.

In step 506, the system displays a graphical user interface (GUI) including a plurality of milestone and checklist items relating to the various second stage tasks. In step 508, each necessary milestone or checklist item is reviewed and undertaken by the developer or other relevant individuals. In the following steps, specific information relating to the particular milestone and checklist items is received by the system and stored so as to be globally accessible to authorized individuals.

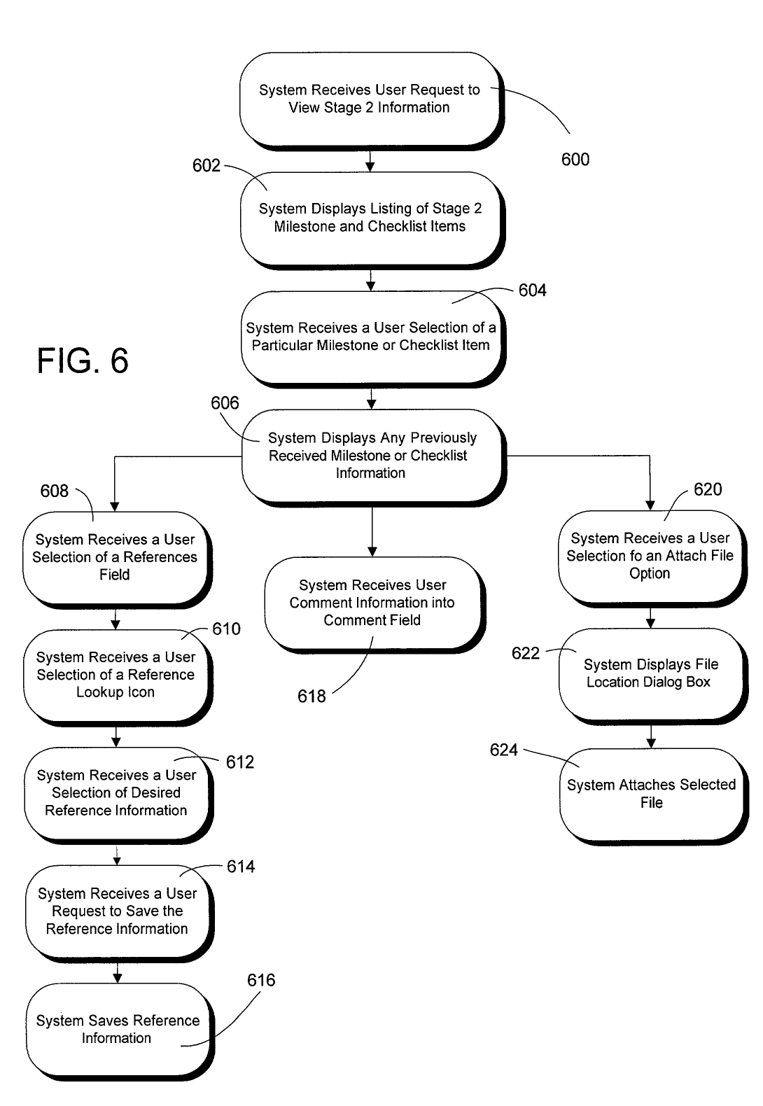

Referring now to FIG. 6, there is shown a flow chart describing a preferred embodiment of a method for displaying and receiving the second stage milestone and checklist information identified above. In step 600, the system receives a user request to view second stage information. Preferably, the information includes the milestone and checklist information as well as additional information such as a projected completion date, a stage status indicator, as well as stage completion percentage information. In step 602, the system displays a listing of milestone and checklist items related to the various second stage tasks (assessment and initiation). Preferably, the listing of milestone and checklist items is formatted such that related checklist items are grouped according to respective milestones. Prior to initiating a second stage approval workflow (discussed in more detail below), specific assessment and initiation information must be received for each milestone.

Relating specifically to the second stage requirements of project assessment and initiation, in one particular embodiment of a product development system implementing the present invention, the following milestones are preferably provided which must be reviewed and completed prior to approval workflow initiation: 1) Cross Functional Team Setup, wherein a team of individuals from a variety of backgrounds are selected to review the introduction process; 2) CTQ Verification; 3) Quality Functional Deployment (QFD) Performance metrics, wherein the various identified CTQ's are prioritized and ranked, are selected to enable the accurate measurement of the CTQ's; 4) Multi-Generational Project Plan (MGPP) Definition and Preparation; 5) Target Costs Definition; 6) Project Safety Assessment; 7) Project Timeline and Resource Definition; and 8) Project Risks Assessment. Each of the above milestones include a plurality of checklist items which assist system users in determining how to best meet the requirements of the related milestone. For example, milestone 7) relating to defining project timelines and resources includes checklist items relating to developing a program plan, determining which resources to use, and determining any customer critical dates. Users may select particular checklist items and attach relevant materials and comment information to assist in determining milestone completion. It should be understood that the required assessment and initiation information for each of these milestones may be received in any desired order and from a variety of interested individuals.

Upon completion of any required milestones and checklist items, a tollgate meeting is generally undertaken between the cross-functional team members to determine whether the necessary steps were completed at the tollgate for the stage approver to render an accurate decision. There will be some projects where some milestones are not critical, and it is up to the team members' discretion if these need to be completed or not for the given tollgate. However, in an alternative embodiment of the present invention, the system denies initiation of the stage approval workflow prior to completion of all necessary milestones or checklist items.

In step 604, the system receives a user selection of a particular milestone or checklist item. Upon receipt of this selection, the system, in step 606, displays or enables the display of (i.e., through a hyperlink or similar icon) any previously received information and comments relating to the selected milestone or checklist item. Preferably, this information is displayed in a plurality of user-definable fields relating to: the status of the selection item; the type of reference materials being attached; the particular reference materials; and user comments relating to the selected item. In particular, a variety of reference types are provided and selected by the user based upon the type of information being submitted to the system. For example, in an Identify Cross Functional Team checklist for the Cross Function Team Setup milestone, the reference type would be users, thereby indicating that the attached or identified references are individuals on the cross functional team. A plurality of reference types are provided so as to enable to attachment and subsequent retrieval of a variety of information.

If the user wants to submit modified, or additional information to a selected milestone or checklist, the system, in step 608, receives a user selection of the references field. In step 610, the system receives a user selection of a reference lookup icon. Based upon the reference type previously identified, the system initiates a searching application for enabling the user to identify the desired reference information. Using the Cross Function Team example above, since the reference type is Users, a selection of the reference lookup icon initiates a searching application relating to available users. In step 612, the system receives a user selection of desired references and includes the references with the selected milestone or checklist. In step 614, the system receives a user request to save the selected reference information. In response, the system, in step 616, saves the selected reference information for review and retrieval by subsequent users.

If the user wants to submit comments or attach additional electronic paperwork, the system in step 618, receives user comment information into the comment field described above. Further, in step 620, the system receives a user selection of an attach file option. In response the system displays, in step 622, a file location dialog box which enables the user to locate and select a particular electronic file for attachment to the selected milestone or checklist item thus enabling the subsequent review and retrieval of the information by other participants. In step 624, the system receives a user selection of a file to attach to the project and saves the file with the other project information.

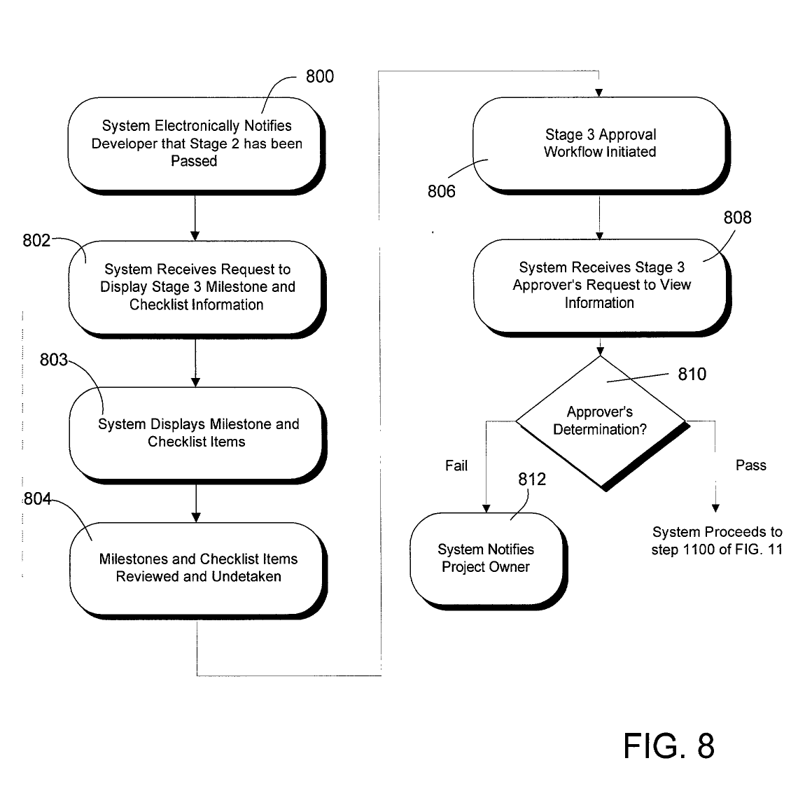

Returning now to FIG. 5, once all required assessment and initiation milestone information as well as any submitted checklist information has been received into the computer system, a second stage approval workflow is initiated by the developer in step 510, wherein a second stage approver is electronically notified about the status of the various pieces of information received into the computer system in the second stage. In step 512, the system receives a second stage approver's request to review the received second stage assessment and initiation information and, in step 514, the system receives the second stage approver's decision as to whether or not to advance the program into stage 3. Preferably, the request to review the received second stage assessment and initiation information is substantially similar to the initial user request to submit the information. That is, the second stage approver simply enters the system like any other user and reviews any or all of the second stage assessment and initiation information contained in the system. If the system receives the second stage approver's decision to reject advancement to stage 3, the system, in step 516, notifies the project owner of this decision. However, if the system receives the second stage approver's decision to advance the program to stage 3, the system proceeds to step 800 of FIG. 8, set forth in detail below.

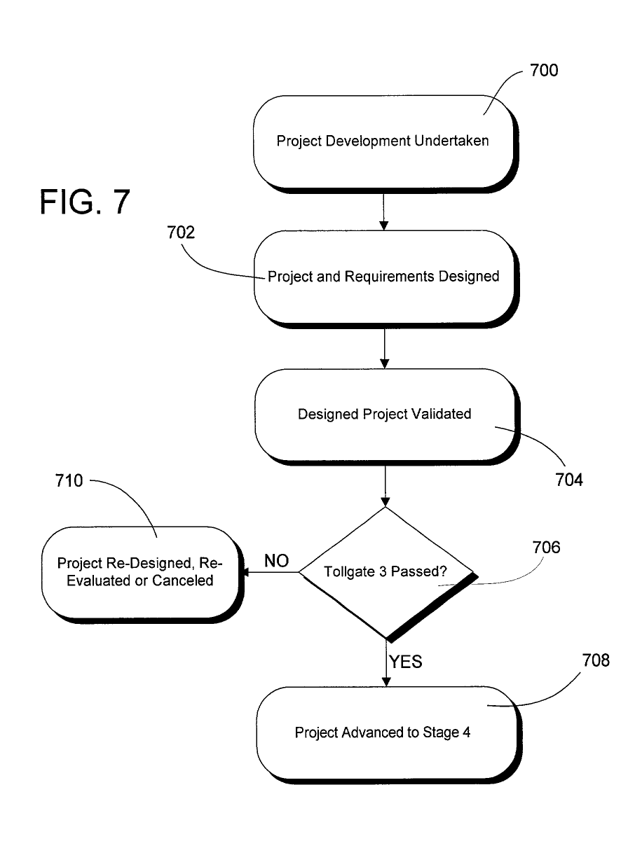

Referring now to FIG. 7, there is shown a flow chart describing the general operation of one embodiment of the third stage relating generally to project development. In step 700, the project is launched such that specific development of the subject matter of the project is undertaken. In step 702, the project and its various requirements are specifically designed. This may include meeting a customer's specific requirements, designing a new product, or determining a new process for performing a task. In step 704, the designed project is validated. At this point, in step 706, the collected project development information and related decisions are subjected to a third tollgate. If it is determined that the program shows sufficient likelihood for success, the tollgate is passed and the project proceeds to the fourth stage in step 708. However, if the third tollgate is not passed, the project is either redesigned, essentially repeating the third stage, re-evaluated within the second stage, or canceled in step 710.

Referring now to FIG. 8, there is shown a flow chart describing a preferred embodiment of a system for facilitating the various third stage tasks set forth above. In step 800, the system electronically notifies the project developer and/or any other relevant individuals that the project has received second stage approval. In step 802, the system receives a request to displays stage 3 milestone and checklist information relating to the various stage 3 project development tasks. The information is displayed in step 803.

Relating specifically to the project development activities of stage 3, in one particular embodiment of a product development system implementing the present invention, the following milestones are preferably provided which must be reviewed and completed prior to approval workflow initiation: 1) CTQ Testing and Verification; 2) Product, Application, and Process Risk Assessment (including freedom to practice initiatives and environmental heath and safety assessments); 3) Manufacturing Plan Development; 4) Raw Materials CTQ Definition; 5) New Material or Processes Design and Formulation; and 6) Field Quality Plan Definition, wherein precautions and steps are taken to ensure that the customer evaluation will be successful. As with the second stage above, each of the above milestones include a plurality of checklist items which assist system users in determining how to best meet the requirements of the associated milestone. For example, milestone 5), relating to the selection of a particular experimental formulation or process, includes at least a checklist relating to the selection or definition of at least one particular formulation or process. Users may select particular checklist items and attach relevant materials and comment information to assist in determining milestone completion. It should be understood that the required project development information for each of these milestones may be received in any desired order and from a variety of interested individuals. As described briefly above, initiation of an approval workflow may be dependent upon completion of all required milestones and checklist items, however, this feature is not required in a preferred embodiment of the present invention.

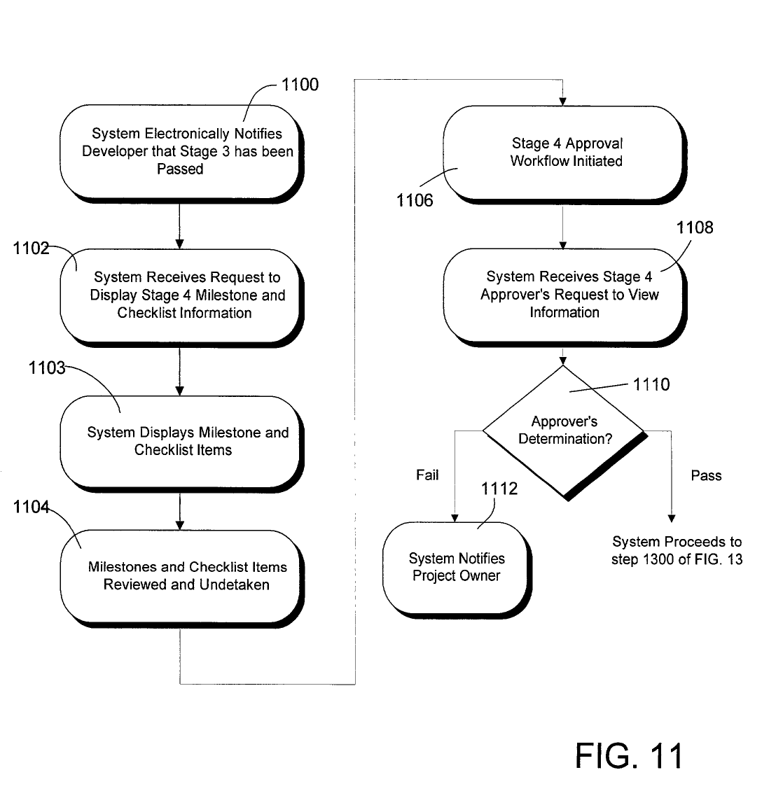

In step 804, each milestone or checklist item is reviewed and undertaken by the developer if necessary for the particular project being developed. Once all required milestone project development information as well as any submitted checklist information has been received, a third stage approval workflow is initiated in step 806, wherein a third stage approver is electronically notified about the status of the various pieces of information received into the computer system in the third stage. In step 808, the system receives a third stage approver's request to review the received third stage project development information and, in step 810, the system receives the third stage approver's decision as to whether or not to advance the program into the fourth stage. Preferably, as above, the request to review the received third stage project development information is substantially similar to the initial user request to submit the information. That is, the third stage approver simply enters the system like any other user and reviews any or all of the third stage information contained in the system. If the system receives the third stage approver's decision to reject advancement to the fourth stage, the system, in step 812, notifies the project owner of this decision. However, if the system receives the third stage approver's decision to advance the program to the fourth stage, the system proceeds to step 1100 of FIG. 11, set forth in detail below for scale-up and sampling.

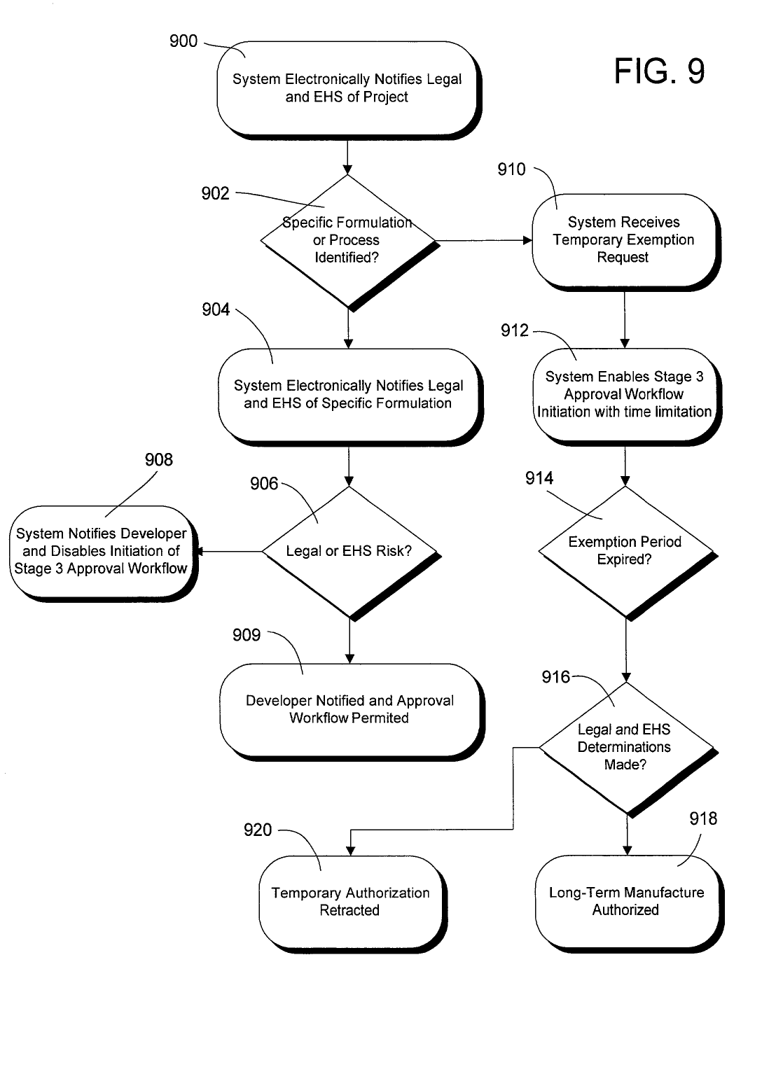

Referring now to FIG. 9, there is shown a flow chart describing one method for performing freedom to practice and environmental health and safety assessments in accordance with the above embodiment of the present invention. In step 900, during the second stage of the inventive system, the computer system electronically notifies both the organization's legal and environmental health and safety (EHS) counsel as to the existence of the project as well as its subject matter. In step 902, during the third stage, the computer system determines whether a specific formulation has been identified for scale-up and testing. If so, the system, in step 904, electronically notifies the legal and EHS counsel about the existence of specific formulation. Upon receiving this notification, the legal and EHS counsel take all available information and determine whether or not the formulation is acceptable for scale-up and sampling. In step 906, the system receives determinations from the legal and EHS counsel as to the freedom to safely implement the process or manufacture the product developed in the third stage and incorporates any written opinions into the third stage project development information.

If it has been determined that either the legal or EHS counsel considers advancement of the project to produce an undue risk of a legal violation, the system, in step 908, notifies the developer of this fact and disables initiation of the third stage approval workflow. However, if is has been determined that neither the legal nor EHS counsel foresee a problem, the system notifies the developer of this fact in step 909 and approval workflow is permitted. Further, as will be discussed in additional detail below, prior to scaling up or manufacturing a product, information must be transmitted between the development computer system and a manufacturing computer system authorizing such manufacture. Prior to obtaining legal and EHS authorization, the system, correspondingly, will not authorize the manufacture of the developed product (or the implementation of a developed process).

Returning momentarily to step 902, in some scenarios, it is not practical for the development team to isolate a particular formulation or process prior to testing. In these cases, the system, in step 910 receives a developer request for an exemption to the requirement for legal and EHS authorization. In this case, the system, in step 912, enables progression into stage 4 through an associated workflow approval and further enables the manufacture of the product (or implementation of the process) for a limited period of time, typically 30 days so that a plurality of formulations or processes may be tested to isolate the best formulation or process.

In step 914, the system determines whether the exemption period has expired. If so, the system then determines, in step 916, whether approvals from legal and EHS have been obtained. If approvals have been obtained, the system, in step 918, authorizes long term manufacture of the product. However, if the approvals have not been obtained, the system, in step 920, retracts the temporary authorization provided earlier and prevents production or practice of the process prior to obtaining such approval.

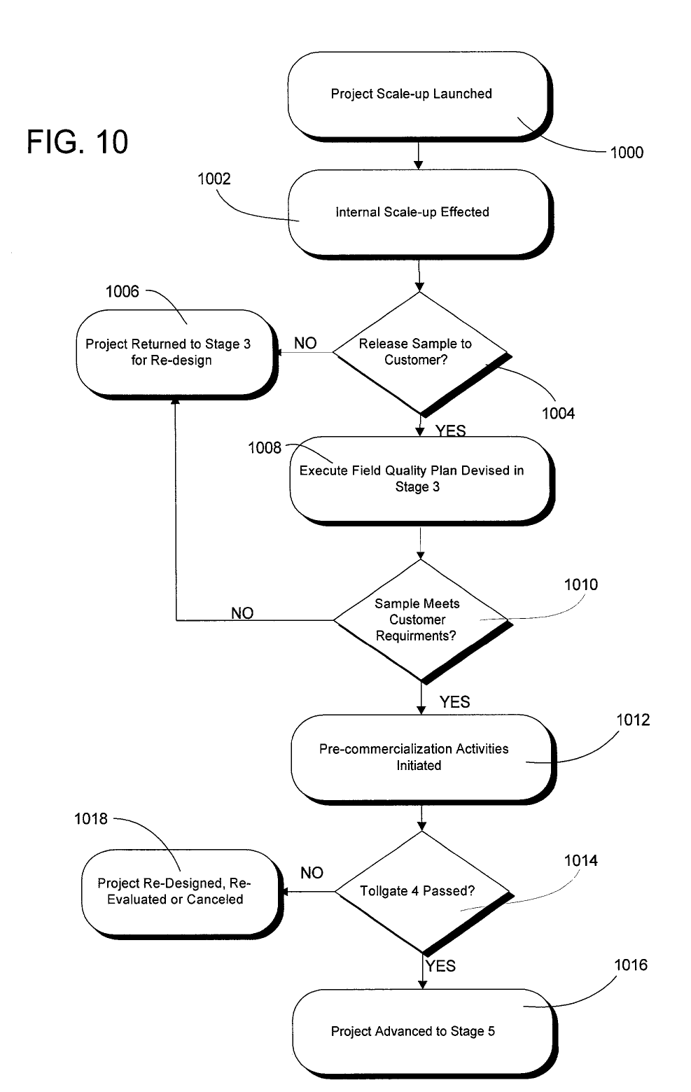

Referring now to FIG. 10, there is shown a flow chart describing the general operation of an embodiment of the fourth stage relating to project scale-up and sampling. In step 1000, the actual project is launched. That is, the project is taken out of the development (i.e. laboratory) stage and scaled up so that it may be tested. Accordingly, in step 1002, an internal scale up of the project is effected using the design approved in the third. As referenced briefly above, effecting an internal scale-up generally preferably includes electronically notifying a manufacturing computer system (or a process implementing system in the case of a new process) of the approved design so that scheduling of the manufacturing of the product can take place on a limited basis for the purposes of testing and evaluation. In step 1004, it is determined whether or not to release a manufactured sample to the customer (or an internal testing group). If the sample release is not approved, the project is sent back to the third stage for re-evaluation and design in step 1006. However, if it is determined to release the sample to the customer the field quality plan defined in the third stage is executed in step 1008. In step 1010, it is next determined whether or not the sample meets the customer's requirements. If not, the project is once again returned to the third stage in step 1006 for further development. However, if the sample is determined to meet the customer's requirements, pre-commercialization activities are initiated in step 1012 and include such tasks as obtaining approval from various standards agencies (e.g., Underwriter's Laboratories, etc.). At this point, any collected scale-up and sampling information and decisions are subjected to a fourth tollgate in step 1014. As with the second and third stages above, if it is determined at this point that the program still shows sufficient likelihood for success, the tollgate is passed and the project proceeds to the fifth stage in step 1016. However, if the fourth tollgate is not passed, the project is either redesigned in the third stage, essentially repeating the third stage, re-evaluated within the second stage, or canceled in step 1018.

Referring now to FIG. 11, there is shown a flow chart describing one preferred embodiment of a system for facilitating the various fourth stage tasks set forth above. In step 1100, the computer system notifies the project developer that the project has received third stage approval. In step 1102, the system receives a request to display the fourth stage milestone and checklist information relating to the various fourth stage project development tasks, and displays the milestones and checklist items in step 1103. In particular, in one embodiment of a product development system implementing the present invention, the following milestones are provided which must be reviewed and completed prior to approval workflow initiation: 1) CTQ's Verified and Tested Against Sample; 2) Agency Approvals Obtained; 3) Customer Feedback and Acceptance Information Documented; and 4) Manufacturing Process and/or Product Specifications Frozen from Subsequent Change. As with the earlier stages, each of the above milestones include a plurality of checklist items which assist system users in determining how to best meet the requirements of the associated milestone. In a similar manner to that described above, users may select particular checklist items and attach relevant materials and comment information to assist in determining milestone completion. It should be understood that the required information for each of these milestones may be received in any desired order and from a variety of interested individuals. As described above, initiation of an approval workflow may be dependent upon completion of all required milestones and checklist items, however, this feature is not required in a preferred embodiment of the present invention.

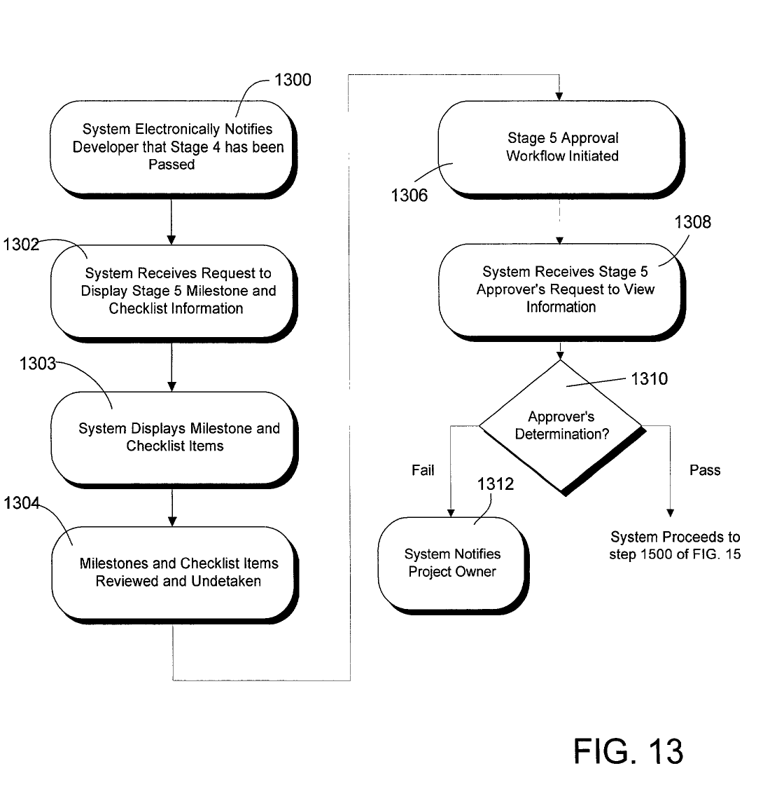

In step 1104, each milestone or checklist item is reviewed and undertaken by the developer if necessary for the particular project being developed. Once all required milestone information as well as any submitted checklist information has been received, a fourth stage approval workflow is initiated in step 1106, wherein a fourth stage approver is electronically notified about the status of the various pieces of information received into the computer system in the fourth stage. In step 1108, the system receives a fourth stage approver's request to review the received fourth stage scale-up and sampling information and, in step 1110, the system receives the fourth stage approver's decision as to whether or not to advance the program into the fifth stage. As above, in a preferred embodiment, the fourth stage approver enters the system like any other user and reviews any or all of the fourth stage information contained in the system as well as any desired information contained within other stages. If the system receives the fourth stage approver's decision to reject advancement to the fifth stage, the system, in step 1112, notifies the project owner of this decision where re-development may be considered. However, if the system receives the fourth stage approver's decision to advance the program to the fifth stage, the system proceeds to step 1300 of FIG. 13, set forth in detail below.

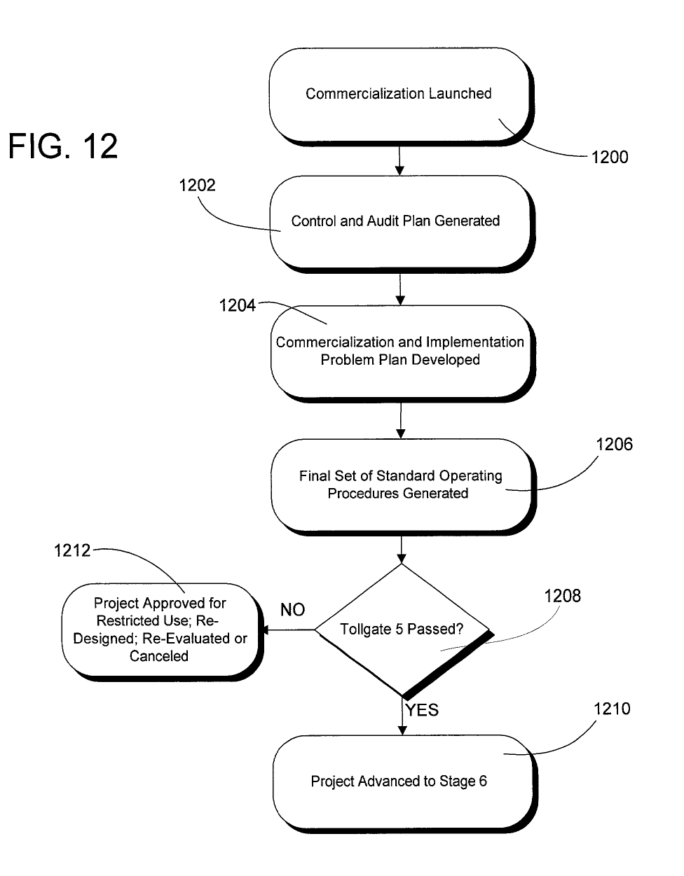

Referring now to FIG. 12, there is shown a flow chart describing the general operation of an embodiment of the fifth stage relating to project commercialization. In step 1200, commercialization of the project is initiated. This process generally entails marketing the project to customers, receiving orders or requests, manufacturing or executing the project, and meeting the various orders taken. In step 1202, a control and audit plan is generated and reviewed, so that areas of risk have backup plans in production as well as a plan to periodically review the production data to look for trends that might indicate production defects or other issues. In step 1204, a plan is developed for meeting any foreseeable obstacles or problems related to commercialization and/or implementation. In step 1206, a final set of standard operating procedures is generated which are to be followed in all future implementations of the product or process. At this point, any collected commercialization information and related decisions are subjected to a fifth tollgate approval in step 1208. If it is determined that the program still shows sufficient likelihood for success, the tollgate is passed and the project proceeds, in step 1210, to the sixth stage. However, if the fifth tollgate is not passed, the project, in step 1212, is either approved for restricted use, redesigned in the third stage, re-evaluated within the second stage, or cancelled.

Referring now to FIG. 13, there is shown a flow chart describing one preferred embodiment of a system for facilitating the various fifth stage tasks set forth above. In step 1300, the system notifies the project developer that the project has received fourth stage approval. In step 1302, the system receives a request to displays fifth stage milestone and checklist information relating to the various fifth stage project development tasks and, in step 1303, the system displays the associated milestones and checklist items. In one embodiment, the following milestones are preferably provided which must be reviewed and completed prior to a fifth stage approval workflow initiation: 1) Proven Manufacturing Capability Standard Operating Procedures Determined; 2) Control and Audit Plan Devised; 3) Risk Assessment Revisited; and 4) Commercialization and Communication Package Devised, wherein the package includes marketing information relating to the commercial launch of the product including, a commercial name, a data sheet, a material safety data sheet (for regulatory purposes), a processing guide, application examples, an advertising plan, etc. As with stages 2-4, each of the above milestones include a plurality of checklist items which assist system users in determining how to best meet the requirements of the associated milestone. Users may select particular checklist items and attach relevant materials and comment information to assist in determining milestone completion. It should be understood that the required information for each of these milestones may be received in any desired order and from a variety of interested individuals. As described above, initiation of an approval workflow may be dependent upon completion of all required milestones and checklist items, however, this feature is not required in a preferred embodiment of the present invention.

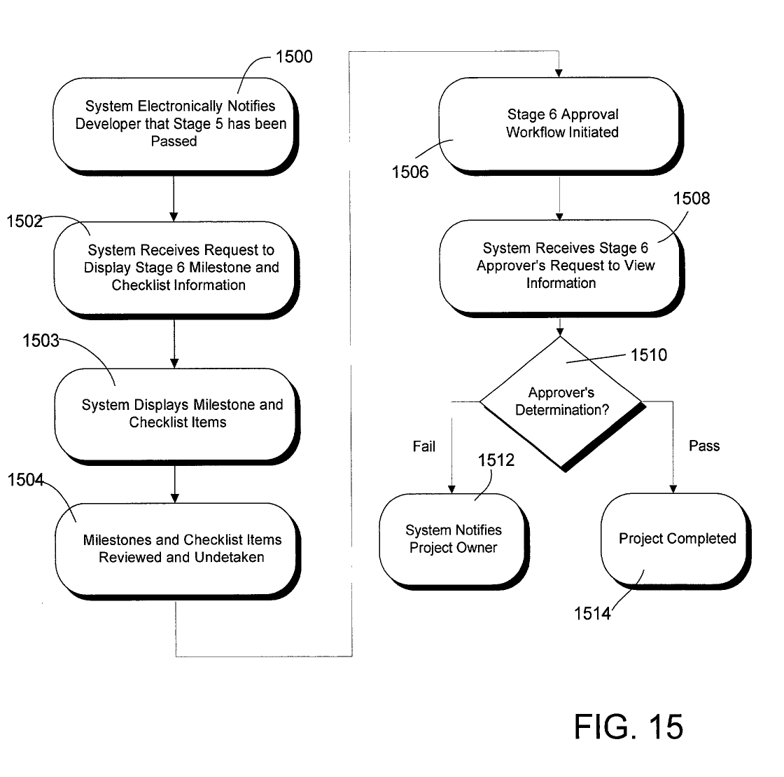

In step 1304, each milestone or checklist item is reviewed and undertaken by the developer (or others) if necessary for the particular project being developed. Once all required milestone information as well as any submitted checklist information has been received, a fifth stage approval workflow is initiated in step 1306, wherein a fifth stage approver is electronically notified about the status of the various pieces of information received into the computer system in the fifth stage. In step 1308, the system receives a stage 5 approver's request to review the received the fifth stage commercialization information and, in step 1310, the system receives the fifth stage approver's decision as to whether or not to advance the program into the sixth stage. Preferably, as above, the fifth stage approver enters the system and reviews any or all of the fifth stage information (or information from other stages) contained in the system. If the system receives the fifth stage approver's decision to reject advancement to the sixth stage, the system, in step 1312, notifies the project owner of this decision. However, if the system receives the fifth stage approver's decision to advance the program to the sixth stage, the system proceeds to step 1500 of FIG. 15, set forth in detail below.

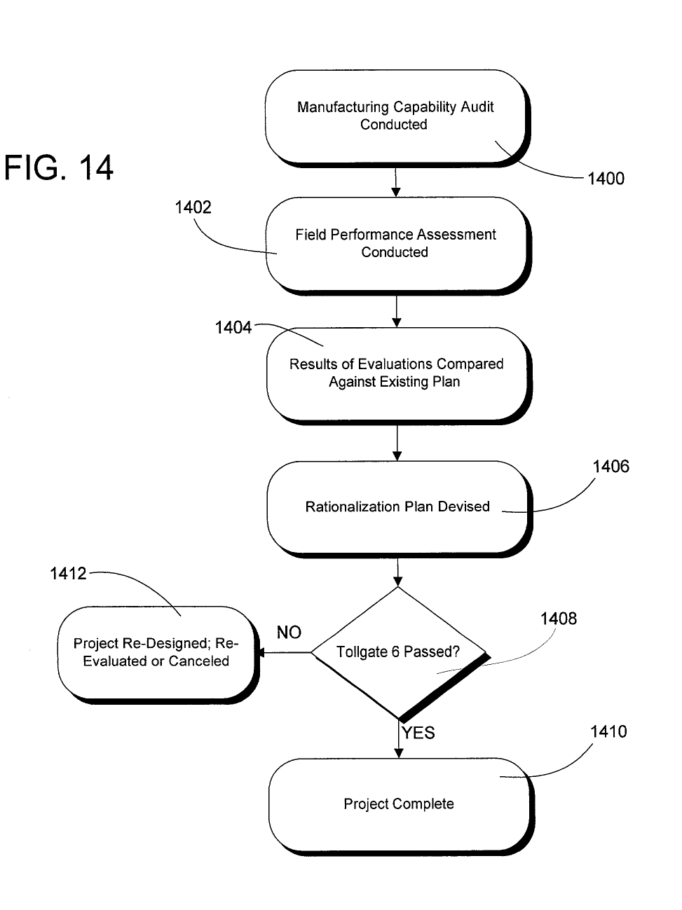

Referring now to FIG. 14, there is shown a flow chart describing the general operation of an embodiment of the sixth stage relating generally to production. Preferably, the sixth stage is a long term stage designed to review the manufacturing or process implementation in accordance with the project. In step 1400, a Manufacturing Capability Audit is conducted in accordance with the plan devised in stage 5, so as to determine the long term capabilities with respect to the project. In step 1402, a Field Performance Assessment is conducted regarding the performance of the manufactured product or implemented process. In step 1404, the results of the above evaluations are compared against the existing plan. In step 1406, a rationalization plan is devised for the continued manufacture or use of the project. At this point, the collected implementation information and related decisions is subjected to a sixth tollgate in step 1408. If it is determined that the program should be maintained as a permanent part of the business, the tollgate is passed in step 1410 indicating that the project is now complete. However, if the sixth tollgate is not passed, the project is either sent back for a redesign in stage 3, re-evaluated within the second stage, or canceled in step 1412.

Referring now to FIG. 15, there is shown a flow chart describing one preferred operation of the sixth stage (210) set forth above. In step 1500, the system notifies the project developer that the project has received fifth stage approval. In step 1502, the system receives a request to displays sixth stage milestone and checklist information relating to the various sixth stage project development tasks and, in step 1503, displays the associated milestone and checklist items. In particular, the following milestones are preferably provided which must be reviewed and completed prior to approval workflow initiation: 1) Manufacturing Capability Audit; 2) Field Performance Assessment; 3) Results vs. Plan Comparison; and 4) Rationalization Plan. As above, each of the above milestones include a plurality of checklist items which assist system users to in determining how to best meet the requirements of the associated milestone. Users may select particular checklist items and attach relevant materials and comment information to assist in determining milestone completion. It should be understood that the required information for each of these milestones may be received in any desired order and from a variety of interested individuals. As described above, initiation of an approval workflow may be dependent upon completion of all required milestones and checklist items, however, this feature is not required in a preferred embodiment of the present invention.

In step 1504, each milestone or checklist item is reviewed and undertaken by the developer if necessary for the particular project being developed. Once all required milestone information as well as any submitted checklist information has been received, a sixth stage approval workflow is initiated in step 1506, wherein a sixth stage approver is electronically notified about the status of the various pieces of implementation information received into the computer system in the sixth stage. In step 1508, the system receives the sixth stage approver's request to review the received sixth stage implementation information and, in step 1510, the system receives the sixth stage approver's decision as to whether or not to approve the completion of the project. Preferably, as above, the request to review the received sixth stage implementation information is substantially similar to the initial user request to submit the information. That is, the sixth stage approver simply enters the system like any other user and reviews any or all of the sixth stage implementation information contained in the system. If the system receives the sixth stage approver's decision to reject completion of the project, the system, in step 1512, notifies the project owner of this decision. However, if the system receives the sixth stage approver's decision to approve completion of the project is completed in step 1514.

By providing a uniform process for designing and implementing a new product or process, the system of the present invention, substantially increases the ability for distributed locations to stay in tune with what each other are doing. Because all products or processes in every location must be introduced in accordance with the above system, added consistency results. In addition to consistency, the above described invention further provides for a uniform system of record for all attempted product or process introductions. Consequently, future developers may search the system to determine if similar work had been done in the past. Further, because of the computer-based nature of the inventive system, transitions between stages are streamlined through electronic notifications and file attachments.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for introducing a new project initiative into a business, comprising the steps of:
receiving, into a computer system, project information related to the new project initiative from a developer of the new project initiative;
opening a new initiative program within the computer system related to the received project information;
progressing, within the computer system, through a series of project development stages wherein the project is developed from conception through manufacture/implementation;
referencing and attaching additional materials to the new initiative program that are relevant to a review and approval process;
electronically notifying at least one approver about the new initiative program; and
receiving an approval determination from the at least one approver indicating whether the new initiative program should advance from a current stage to a next stage.

2. The method of claim 1, wherein the step of receiving project information further comprises the steps of:
receiving program type information related to a type of initiative being introduced;
receiving owner identification information related to a individual responsible for the program; and
receiving marketing tollgate information relating to information collected during an initial determination by a marketing group regarding whether to open the new initiative program.

3. The method of claim 1, wherein the step of opening a new initiative program further comprises the steps of:
assigning a unique program identifier to the new project initiative;
displaying a new project initiative program graphical user interface to the developer, wherein the new initiative program graphical user interface includes a plurality of stages, milestones and checklist items that together outline to process for introducing the new project initiative to the business.

4. The method of claim 1, wherein the step of progressing through a series of project development stages further comprises the steps of:
progressing through a first stage relating to market development of the new project initiative;
progressing through a second stage relating to assessment and initiation of the new project initiative;
progressing through a third stage relating to development of the new project initiative;
progressing through a fourth stage relating to scale-up and sampling of at least one preferred implementation of the new project initiative;
progressing through a fifth stage relating to commercialization of a selected one of the at least one preferred implementation of the new project initiative; and
progressing through a sixth stage relating to implementation of the selected one of the at least one preferred implementation of the new project initiative.

5. The method of claim 4, wherein the step of progressing through a first stage relating to market development of the new project initiative further comprises the steps of:
determining whether a first tollgate should be passed indicating that the new project initiative has been approved for introduction;
receiving, into the computer system, an indication that introduction of the new project initiative has been approved if it is determined that the first tollgate should be passed;
receiving marketing information relating to information collected during the first tollgate determination;
displaying an indication that the first tollgate has been passed; and
permitting advancement to the second stage.

6. The method of claim 4, wherein the step of progressing through a second stage relating to assessment and initiation of the new project initiative further comprises the steps of:
receiving, by the computer system, a request to view a collection of milestones and checklist items associated with the second stage, wherein at least one of the milestones requires completion on the part of a user;
receiving, into the computer system, project assessment and initiation information for completing the at least one milestone requiring completion; and
electronically notifying at least a second stage approver that a second stage approval determination must be made.

7. The method of claim 6, further comprising the steps of:
receiving the second stage approval determination from at least the second stage approver regarding whether the new project initiative should be advanced to the third stage;
permitting advancement to the third stage if the determination from the second stage approver indicates that the new project initiative should be advanced to the third stage; and
denying advancement to the third stage if the determination from the second stage approver indicates that the new project initiative should not be advanced to the third stage.

8. The method of claim 6, further comprising the steps of:
receiving a request to initiate a second stage approval workflow;
determining whether all milestones requiring completion have been completed;
initiating the second stage approval workflow if it is determined that all milestones requiring completion have been completed, wherein the second stage approval workflow includes the step of:
electronically notifying at least the second stage approver that a second stage approval determination must be made; and
receiving a request from at least the second stage approver to review at least the project assessment initiation information for completing the at least one milestone requiring completion.

9. The method of claim 8, further comprising the steps of:
receiving the second stage approval determination from at least the second stage approver regarding whether the new project initiative should be advanced to the third stage;
permitting advancement to the third stage if the determination from the second stage approver indicates that the new project initiative should be advanced to the third stage; and
denying advancement to the third stage if the determination from the second stage approver indicates that the new project initiative should not be advanced to the third stage.

10. The method of claim 4, wherein the step of progressing through a third stage relating to development of the new project initiative further comprises the steps of:
receiving, by the computer system, a request to view a collection of milestones and checklist items associated with the third stage, wherein at least one of the milestones requires completion on the part of a user;
receiving, into the computer system, project development information for completing the at least one milestone requiring completion; and
electronically notifying at least a third stage approver that a third stage approval determination must be made.

11. The method of claim 10, wherein the step of receiving, into the computer system, project development information for completing the at least one milestone requiring completion further comprises the step of receiving formulation information relating to at least one preferred implementation of the new project initiative.

12. The method of claim 11, further comprising the steps of:
electronically notifying at least legal and environmental health and safety representatives regarding the formulation information relating to at least one preferred implementation of the new project initiative;
receiving a request from at least the legal and environmental heath and safety representatives to review the formulation information;
determining whether an approval from at least the legal and environmental health and safety representatives has been received;
denying advancement to the fourth stage if it is determined that the approval from the at least the legal and environmental health and safety representatives has not been received;
receiving a request for a temporary exemption to the requirement for the approval from the at least the legal and environmental health and safety representatives;
permitting temporary advancement to the fourth stage upon receipt of the request for a temporary exemption.

13. The method of claim 12, wherein the temporary exemption is a 30 day exemption.

14. The method of claim 10, further comprising the steps of:
receiving the third stage approval determination from at least the third stage approver regarding whether the new project initiative should be advanced to the fourth stage;
permitting advancement to the fourth stage if the determination from the third stage approver indicates that the new project initiative should be advanced to the fourth stage; and
denying advancement to the fourth stage if the determination from the third stage approver indicates that the new project initiative should not be advanced to the fourth stage.

15. The method of claim 10, further comprising the steps of:
receiving a request to initiate a third stage approval workflow;
determining whether all milestones requiring completion have been completed;
initiating the third stage approval workflow if it is determined that all milestones requiring completion have been completed, wherein the third stage approval workflow includes the step of:
electronically notifying at least the third stage approver that a third stage approval determination must be made; and
receiving a request from at least the third stage approver to review at least the project development information for completing the at least one milestone requiring completion.

16. The method of claim 15, further comprising the steps of:
receiving the third stage approval determination from at least the third stage approver regarding whether the new project initiative should be advanced to the fourth stage;
permitting advancement to the fourth stage if the determination from the third stage approver indicates that the new project initiative should be advanced to the fourth stage; and
denying advancement to the fourth stage if the determination from the third stage approver indicates that the new project initiative should not be advanced to the fourth stage.

17. The method of claim 4, wherein the step of progressing through a fourth stage relating to scale-up and sampling of at least one preferred implementation of the new project initiative further comprises the steps of:
receiving, by the computer system, a request to view a collection of milestones and checklist items associated with the fourth stage, wherein at least one of the milestones requires completion on the part of a user;
receiving, into the computer system, preferred implementation scale-up and sampling information for completing the at least one milestone requiring completion; and
electronically notifying at least a fourth stage approver that a fourth stage approval determination must be made.

18. The method of claim 17, wherein the step of receiving, into the computer system, preferred implementation scale-up and sampling information for completing the at least one milestone requiring completion further comprises the step of receiving customer feedback information relating to the at least one preferred implementation of the new project initiative.

19. The method of claim 17, further comprising the steps of:
receiving the fourth stage approval determination from at least the fourth stage approver regarding whether the new project initiative should be advanced to the fifth stage;
permitting advancement to the fifth stage if the determination from the fourth stage approver indicates that the new project initiative should be advanced to the fifth stage; and
denying advancement to the fifth stage if the determination from the fourth stage approver indicates that the new project initiative should not be advanced to the fifth stage.

20. The method of claim 17, further comprising the steps of:
receiving a request to initiate a fourth stage approval workflow;
determining whether all milestones requiring completion have been completed;
initiating the fourth stage approval workflow if it is determined that all milestones requiring completion have been completed, wherein the fourth stage approval workflow includes the step of:
electronically notifying at least the fourth stage approver that a fourth stage approval determination must be made; and
receiving a request from at least the fourth stage approver to review at least the preferred implementation scale-up and sampling information for completing the at least one milestone requiring completion.

21. The method of claim 20, further comprising the steps of:
receiving the fourth stage approval determination from at least the fourth stage approver regarding whether the new project initiative should be advanced to the fifth stage;
permitting advancement to the fifth stage if the determination from the fourth stage approver indicates that the new project initiative should be advanced to the fifth stage; and
denying advancement to the fifth stage if the determination from the fourth stage approver indicates that the new project initiative should not be advanced to the fifth stage.

22. The method of claim 4, wherein the step of progressing through a fifth stage relating to commercialization of a selected one of the at least one preferred implementation of the new project initiative further comprises the steps of:
receiving, by the computer system, a request to view a collection of milestones and checklist items associated with the fifth stage, wherein at least one of the milestones requires completion on the part of a user;
receiving, into the computer system, preferred implementation commercialization information for completing the at least one milestone requiring completion; and
electronically notifying at least a fifth stage approver that a fifth stage approval determination must be made.

23. The method of claim 22, wherein the step of receiving, into the computer system, preferred implementation commercialization information for completing the at least one milestone requiring completion further comprises the step of receiving capability and audit plan information relating to the selected one of the at least one preferred implementation of the new project initiative.

24. The method of claim 22, further comprising the steps of:
receiving the fifth stage approval determination from at least the fifth stage approver regarding whether the new project initiative should be advanced to the sixth stage;
permitting advancement to the sixth stage if the determination from the fifth stage approver indicates that the new project initiative should be advanced to the sixth stage; and
denying advancement to the sixth stage if the determination from the fifth stage approver indicates that the new project initiative should not be advanced to the sixth stage.

25. The method of claim 22, further comprising the steps of:
receiving a request to initiate a fifth stage approval workflow;
determining whether all milestones requiring completion have been completed;
initiating the fifth stage approval workflow if it is determined that all milestones requiring completion have been completed, wherein the fifth stage approval workflow includes the step of:
electronically notifying at least the fifth stage approver that a fifth stage approval determination must be made; and
receiving a request from at least the fifth stage approver to review at least the commercialization information for completing the at least one milestone requiring completion.

26. The method of claim 25, further comprising the steps of:
receiving the fifth stage approval determination from at least the fifth stage approver regarding whether the new project initiative should be advanced to the sixth stage;
permitting advancement to the sixth stage if the determination from the fifth stage approver indicates that the new project initiative should be advanced to the sixth stage; and
denying advancement to the sixth stage if the determination from the fifth stage approver indicates that the new project initiative should not be advanced to the sixth stage.

27. The method of claim 4, wherein the step of progressing through a sixth stage relating to implementation of a selected one of the at least one preferred implementation of the new project initiative further comprises the steps of:
receiving, by the computer system, a request to view a collection of milestones and checklist items associated with the sixth stage, wherein at least one of the milestones requires completion on the part of a user;
receiving, into the computer system, preferred implementation performance information for completing the at least one milestone requiring completion; and
electronically notifying at least a sixth stage approver that a sixth stage approval determination must be made.

28. The method of claim 27, wherein the step of receiving, into the computer system, preferred implementation performance information for completing the at least one milestone requiring completion further comprises the step of receiving at least field performance assessment results information relating to the selected one of the at least one preferred implementation of the new project initiative.

29. The method of claim 27, further comprising the steps of:
receiving the sixth stage approval determination from at least the sixth stage approver regarding whether a status of the new project initiative should be advanced to complete;
permitting status advancement to complete if the determination from the sixth stage approver indicates that the status of the new project initiative should be advanced to complete; and
denying status advancement complete if the determination from the sixth stage approver indicates that the status of the new project initiative should not be advanced to complete.

30. The method of claim 27, further comprising the steps of:
receiving a request to initiate a sixth stage approval workflow;
determining whether all milestones requiring completion have been completed;
initiating the sixth stage approval workflow if it is determined that all milestones requiring completion have been completed, wherein the sixth stage approval workflow includes the step of:
electronically notifying at least the sixth stage approver that a sixth stage approval determination must be made; and
receiving a request from at least the sixth stage approver to review at least the performance information for completing the at least one milestone requiring completion.

31. The method of claim 30, further comprising the steps of:
receiving the sixth stage approval determination from at least the sixth stage approver regarding whether a new project initiative program status should be updated to complete;
advancing the status of the new project initiative program to complete if the determination from the sixth stage approver indicates that the new project initiative program status should be updated to complete; and
denying status advancement of the new project initiative program to complete if the determination from the sixth stage approver indicates that the new project initiative program status should not be updated to complete.

32. A method for introducing a new project initiative into a business, comprising the steps of:
compiling new project initiative marketing information;
determining whether the new project initiative should be introduced to the business based upon the new project initiative marketing information;
receiving, into a computer system, new project initiation information related to the project if it is determined that the new project initiative should be introduced;
receiving, into the system, at least assessment and initiation information related to a second stage of the new project initiative;
electronically notifying at least a second stage approver that a second stage approval must be made based upon at least the assessment and initiation information;
receiving, at least from the second stage approver, a determination regarding whether the project should be advanced from the second stage to a third stage;
advancing the project to the third stage if the determination indicates that the new project initiative should be advanced from the second stage to the third stage;
receiving, into the system, at least project development information related to a third stage of the new project initiative;
electronically notifying at least a third stage approver that a third stage approval must be made based upon at least the project development information;
receiving, at least from the third stage approver, a determination regarding whether the project should be advanced from the third stage to a fourth stage;
advancing the project to the fourth stage if the determination indicates that the new project initiative should be advanced from the third stage to the fourth stage;
receiving, into the system, at least preferred implementation scale-up and sampling information related to a fourth stage of the new project initiative;
electronically notifying at least a fourth stage approver that a fourth stage approval must be made based upon at least the preferred implementation scale-up and sampling information;
receiving, at least from the fourth stage approver, a determination regarding whether the project should be advanced from the fourth stage to a fifth stage;
advancing the project to the fifth stage if the determination indicates that the new project initiative should be advanced from the fourth stage to the fifth stage;
receiving, into the system, at least preferred implementation commercialization information related to a fifth stage of the new project initiative;
electronically notifying at least a fifth stage approver that a fifth stage approval must be made based upon at least the preferred implementation commercialization information;
receiving, at least from the fifth stage approver, a determination regarding whether the project should be advanced from the fifth stage to a sixth stage;
advancing the project to the sixth stage if the determination indicates that the new project initiative should be advanced from the fifth stage to the sixth stage;
receiving, into the system, at least preferred implementation performance information related to a sixth stage of the new project initiative;
electronically notifying at least a sixth stage approver that a sixth stage approval must be made based upon at least the preferred implementation performance information;
receiving, at least from the sixth stage approver, a determination regarding whether a status of the new project initiative should be updated to complete; and
advancing the status of the project to complete if the determination indicates that the status of the new project initiative should be updated to complete.
